(19) United States
(12) Patent Application Publication
(10) Pub. No.: US 2014/0158055 A1
(43) Pub. Date: Jun. 12, 2014

(54) ADAPTOR FITTING

(71) Applicant: Robert Dymock MCINTYRE, Hunterville (NZ)

(72) Inventors: Robert Dymock MCINTYRE, Hunterville (NZ); Rex Allan PIKE, Masterton (NZ)

(21) Appl. No.: 13/896,359

(22) Filed: May 17, 2013

(30) Foreign Application Priority Data
May 17, 2012 (NZ) 600033
Mar. 5, 2013 (NZ) 607882

(51) Int. Cl. A01K 9/00; F16L 5/10

(52) U.S. Cl. CPC A01K 9/005; F16L 5/10
USPC 119/71; 285/139.2

(57) ABSTRACT

An adaptor fitting 10 by which an animal feeding teat can be mounted to a feeder F. The adaptor 10 has a first section 11 to which the feeding teat can be fitted. A second section 12 is engagable with the first section 11. The first and second sections 11 and 12 are, in use, engagable through an opening O in the wall W of a feeder F such that the first and second sections are respectively located at the outer and inner sides of the wall W. The second section 12 has a sealing part 26 that, upon relative movement between the first and second sections 11 and 12 during fitment of the adaptor to the wall W, engages into the material from which the wall W is made. This creates a seal around the opening O in the wall W.

### BACKGROUND OF THE INVENTION

This invention relates to an adaptor fitting and more particularly an adaptor fitting for mounting a feeding teat to an animal feeder.

It is known to mount a feeding teat to a feeder whereby an animal can suckle the teat and derive a supply of liquid feed from within the feeder. The present invention has been designed primarily for teat feeders intended for feeding young animals such as calves, lambs, deer etc.

In this specification reference will be made to an animal feeder and this will encompass all forms of gravity feeders that have one of more openings with the, or each of which a feeding teat can be associated. It will be appreciated by those skilled in the art that the invention has application to many different forms of feeders such as single “bucket” feeders, multiple teat fence hung or free standing feeders, mobile feeders and the like.

With some animal feeders an opening is provided in the wall of the feeder for fitment of the feeding teat. The wall can be the wall of a container or trough (or compartment in the feeder) or a manifold of a mobile feeder. The feeder can have a plurality of openings with each of which a teat can be mounted.

Typically teats are fitted by pulling the feeding end of the teat through the opening and then by applying sufficient force pulling part of the base end of the teat into the opening so that it is seated in a substantially sealing manner in the opening. Such pull-through teats are well known, however, they can be difficult to fit. One reason is the amount of force that needs to be applied to get the teat to seat in the opening. This form of fitting a teat is still used with some feeders.

To overcome the problems that can be associated with pull-through teats it is known to provide a threaded wall around the opening so that a cap with a teat fitted thereto can be screwed onto the threaded wall. For example, the cap can itself have a threaded bore into which the threaded base end of a threaded teat (see New Zealand patent specification No. 504554) can be fitted. However, incorporating the threaded wall (which typically is spun welded onto the feeder) represents an additional manufacturing operation when making the feeder and the consequential cost needs to be accounted for.

Also a situation that typically arises with OEM's using pull-through teats on their feeders is that an end user can be restricted from using a more preferred form of teat that cannot fit satisfactorily in a pull through manner.

### SUMMARY OF THE INVENTION

An object of the present invention is thus to provide an adaptor fitting for an animal feeder to permit the mounting of a feeding teat to the feeder in a simple yet effective manner or to at least provide the public with a useful choice.

Broadly in one aspect of the invention there is provided an adaptor fitting which includes a first section to which a feeding teat can be fitted, a second section that is engagable with the first section, the first and second sections being, in use, able to engage through an opening in the wall of a feeder such that the first and second sections are respectively located at the outer and inner sides of the wall, the second section having a sealing part that, upon relative movement between the first and second sections during fitment thereof to the wall, engages into the material from which the wall is made to thereby create a seal around the opening in the wall.

Preferably the first and second sections are engagable by first and second engagement elements adapted to inter-engage via the opening in the feeder wall and cause the relative movement.

In the preferred form the second section has a projecting portion that in use is engagable with an engagement surface of the feeder.

Preferably the second section has a pair of opposed projecting portions.

In the preferred form the pair of projecting portions are diametrically opposed relative to an axis along which the relative movement can occur.

In a preferred form the projecting portions are of different length.

In a preferred form the sealing part is an annular tapering wall.

In a preferred form the annular tapering wall tapers toward an outer edge. In a preferred form the edge is a substantially narrow edge that can bite into the material from which the wall of the feeder is constructed and thereby create a seal.

In one preferred form the tapering wall is formed integrally with the second section.

In a further form of the invention a second sealing part extends from the first section and preferably is in the form of a annular wall that is tapered toward an outer edge.

Preferably the first engagement element is a threaded projection and the second engagement element is a threaded opening.

In a preferred embodiment of the invention the first section has the threaded projection.

In one form a peripheral outer surface of the first section is provided with a gripping surface.

Preferably the first section has a threaded bore into which a threaded portion of a feeding teat can screw.

In the preferred form the first and second sections are each made from a suitable plastics material with the second section made from a material whereby the annular tapered wall can bite into the wall of the feeder. Preferably the plastics material is a hard plastic such as nylon.

In a second broad aspect there is provided an adaptor fitting as above defined in the first broad aspect in combination with an animal feeder.

In the preferred form the second section has a projecting portion that in use engages with an engagement surface of the feeder

Preferably the engagement surface is a floor of the feeder adjacent to the opening in the feeder wall.

In a third broad aspect there is provided a kit of parts comprising an adaptor fitting as defined in the first broad aspect and an animal feeding teat able to be mounted to the adaptor fitting.

### BRIEF DESCRIPTION OF THE DRAWINGS

In the following more detailed description of one embodiment of an adaptor according the present invention reference will be made to the accompanying drawings in which:

FIG. 1 is an adaptor incorporating the present invention when mounted with an opening in a wall of an animal feeder,

FIG. 2 is an elevation view in cross section of the first or body section of the adaptor shown in FIG. 1,

FIG. 3 is a plan view of the first section shown in FIG. 1,

FIG. 4 is a plan view of the second or nut section of the adaptor shown in FIG. 1,

FIG. 5 is cross section elevation view of the second section shown in FIG. 4,

FIG. 6 is an isometric view of a second form of the first section,

FIG. 7 is an isometric view of a ring element for fitting to the first section of FIG. 6,

FIG. 8 is an elevation view of the first section of FIG. 6 fitted to a second form of the second section (see FIG. 12),

FIG. 9 is a cross sectioned view on line A-A of FIG. 8,

FIG. 10 is detail view “A” of FIG. 9,

FIG. 11 is detail view “B” of FIG. 9,

FIG. 12 is an isometric view of the second form of the second portion,

FIG. 13 is an elevation view of the second section of FIG. 12,

FIG. 14 is a cross section view on line B-B of FIG. 13, and

FIG. 15 is detail “C” of FIG. 14.

### DESCRIPTION OF PREFERRED EMBODIMENTS OF THE INVENTION

In the drawings there are shown embodiments of an adaptor fitting incorporating the invention. It will be appreciated by the skilled addressee that an adaptor fitting incorporating the invention can be achieved by way of embodiments, which differ from those described and illustrated in the present specification.

The adaptor fitting 10 as illustrated in the drawings includes a first section or body 11 and a second section or nut 12. In the preferred form the body 11 and nut 12 can be combined by engagement elements in the form of a threaded projection 13 of the body 11 and a threaded central opening 14 of the nut 12, the projection 13 being threadingly engagable in the opening 14. When the threaded projection 13 is threaded into opening 14 relative movement between the body and nut can occur along an axis which corresponds with the axis of the projection 13.

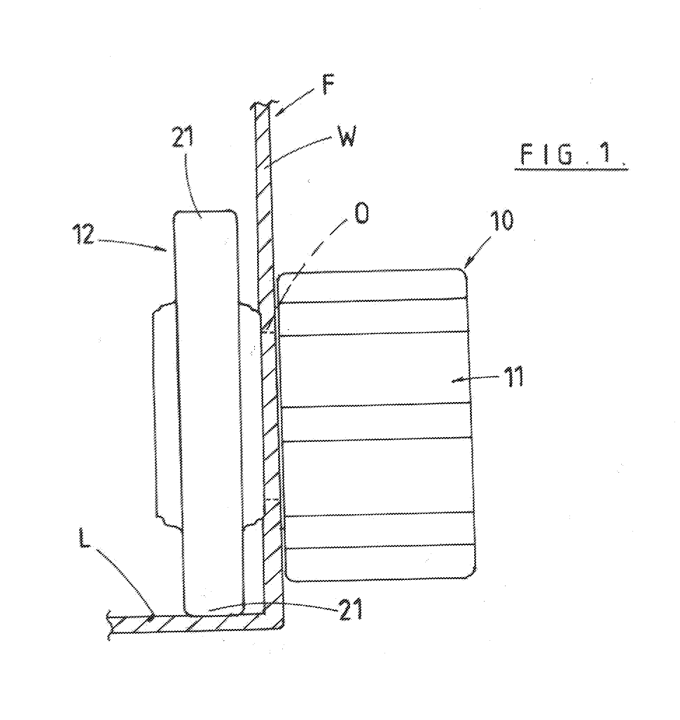

The combination of body 11 and nut 12 is shown in FIG. 1 when the adaptor 10 is engaged with an opening O in the wall W of an animal feeder F.

In the illustrated form of the adaptor 10 the body 11 has a threaded bore 15. The thread 16 in the bore 15 is of a form that is intended for the mounting of an animal-feeding teat (not shown). This enables a screw-threaded teat of the type sold under the trade mark PEACH (and described and claimed in New Zealand patent specification No. 504554) to be screwed into the bore 15 of body 11. This is achieved by the screw threaded mounting portion of the teat being screwed into the threaded bore 15 so that the teat projects outwardly from the end surface 17 of the body 11.

It will be appreciated by the skilled person that a screw-threaded bore 15 is not the only way in which a teat can be connected/mounted to the adaptor 10. For example, the bore 15 would take a different form if the teat were to be attached to the adaptor fitting 10 by some other means such as say a bayonet type fitting.

In the preferred form the body 11 is moulded in one piece from a suitable plastics material. A hard plastics material such as nylon (glass filled being an option) can be used.

The peripheral outer surface of the body 11 is preferably formed with grooves 18 to provide the user with a secure grip of the body when it is being installed with an animal feeder. It will be evident to those skilled in the art that other forms or providing a gripping surface can be used.

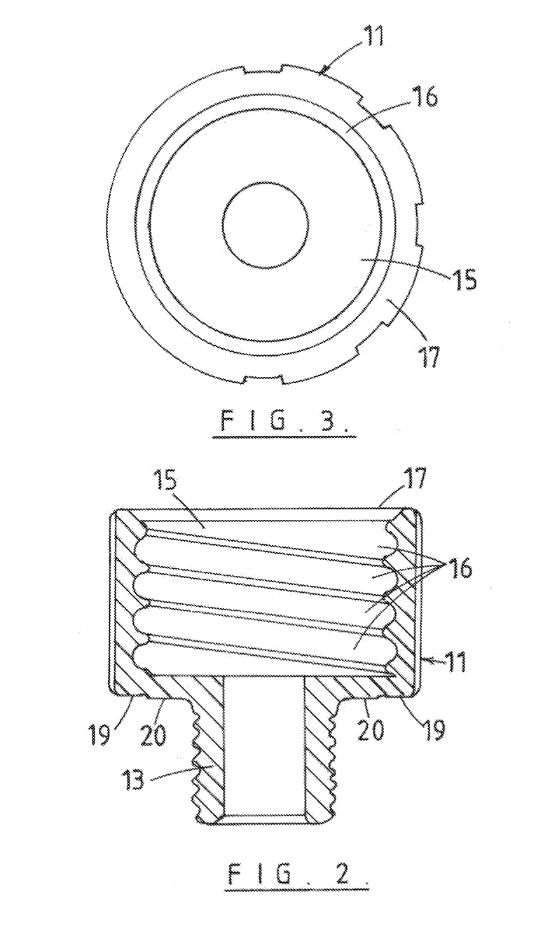

In one preferred form of the body 11 the surface 19 of the body 11 from which the threaded projection 13 projects has a land 20 around the root end of the threaded projection 13. The land 20 is preferably concentric with the central longitudinal axis of the threaded projection 13. The land 20 stands proud of the surface 19 by only a small amount as can be seen in FIG. 2 of the drawings.

In another form of the invention the land 20 is not present.

As shown in FIGS. 9 and 11, which shown a further form of the body 11, there is provided an annular tapered wall 30 that is concentric with the projection 13. As shown the tapered wall 30 projects from the land 20 but can project directly from surface 19 if no land is present.

The purpose of the tapered wall will be apparent from the following disclosure of the construction and use of the tapered wall 26.

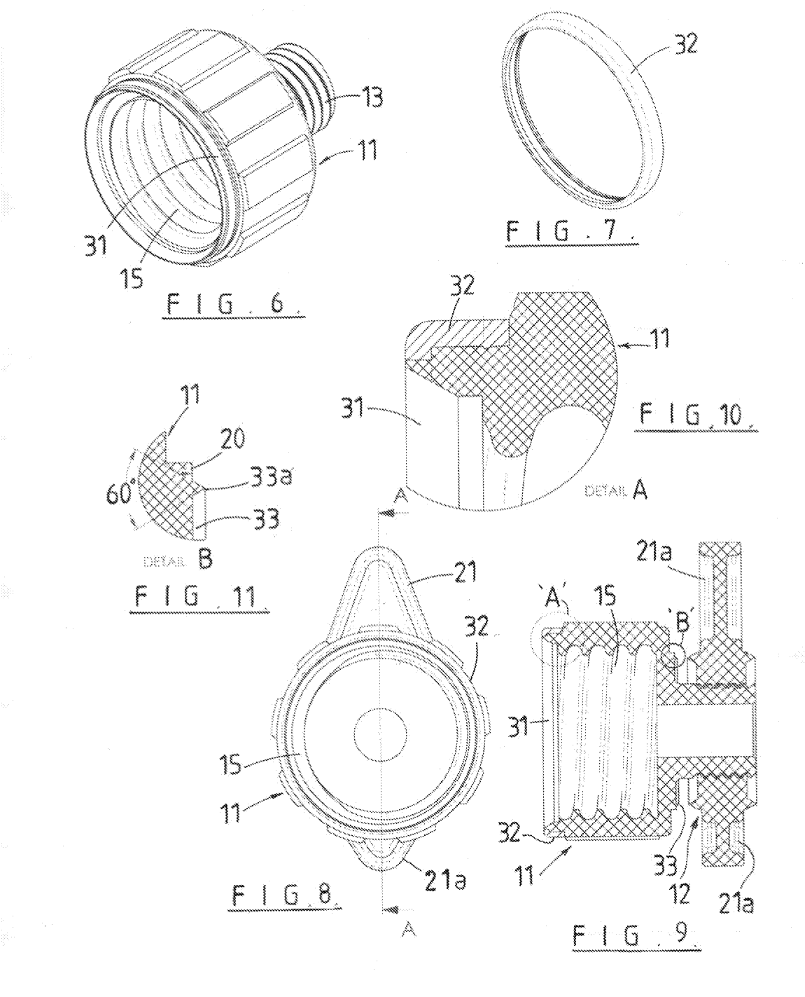

The further form of the body 11 as shown in FIGS. 6, 8, 9 and 10 the end surface 17 of the body 11 can be in the form of a turret 31 to which a ring 32 (FIG. 7) can be fitted. In the preferred form the fitting of the ring 32 is in a snap lock arrangement as is evident from the detail drawing in FIG. 10.

The ring 32 provides an identification means. For example it can carry one of more trade marks or branding. It can also be in a colour contrasting with that of the body 11 for once again trade mark purposes (e.g. the colour that is the subject of New Zealand trade mark registration No. 802521) or colour coding purposes to identify different models of adaptor 10.

The second section or nut 12 is preferably formed from a suitable plastics material and more preferably from an acetyl, nylon or glass filled nylon.

The nut 12 is, in the preferred form, symmetrical about the threaded central opening 14. In the preferred form it has a pair of diametrically opposed projections or “wings” 21. As can be seen from FIG. 5 of the drawings each wing 21 in cross section has a web 22 that projects from the body 23 of the nut 12 and about the web 22 is a rim 25.

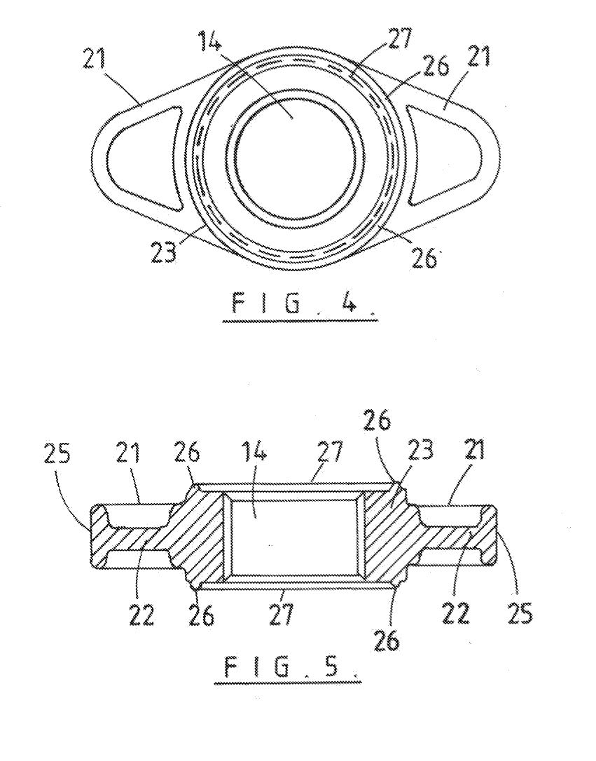

FIGS. 4 and 5 show the wings 21 as being of substantially the same length. However, in an alternative form of the nut 12 the wings 21a are of different lengths. The reason for this will be apparent from later in the following disclosure.

In the preferred form the nut 12 is also symmetrical about a line through the centre of the webs 22. As a result either side of the nut 12 can be the leading side when the nut 12 is screwed onto the threaded projection 13 of the body 11.

The wings 21 and the body 23 of the nut are, in the preferred form, of a configuration such that a spanner cannot be applied thereto when fitting the nut 12 onto the projecting threaded projection 13 during installation of the adaptor 10 to an animal feeder

Surrounding (preferably concentrically) the opening 14, but spaced therefrom, is a continuous annular wall 26. The wall 26 is, in cross-section of an inwardly tapering configuration from the root end of the wall 26. Thus the outer distal end 27 of the wall 26 is the narrowest width of the wall. In a preferred form the distal end forms a somewhat sharp edge as will be apparent for the following.

In use, the body 11 will be positioned at the outer surface of the wall W of the feeder F and the threaded projection 13 inserted into the opening O in the wall W. When so inserted the nut 12 is introduced, from the inside of the feeder, onto the end of the threaded portion 13. The body 11 is then rotated to cause the threads of the body 11 and nut 12 the draw the land 20 and the leading edge 27 of the wall 26 into contact with the respective outer and inner surfaces of the wall W.

In the form of the body 11 shown e.g. in FIGS. 9 and 11 the leading edge 33a of the tapered wall 33 will bite into the outer surface of the feeder wall. In this way a sealing effect will be created around the opening O at each end thereof.

Most animal feeders these days work on a gravity feed system which means that the opening O in the wall W of the feeder F will be adjacent to the floor L of the feeder F. Consequently, one of the wings 21 of the nut 12 will come into contact with floor L shortly after the body 11 and nut 12 are inter-engaged because the length of the wing 21 relative to the central axis of the opening 14 will be greater than the distance between the centre of the opening O and the floor L. This engagement of one of the wings 21 with the floor L will prevent the nut from rotating as the projection 13 of the body 11 is screwed into opening 14.

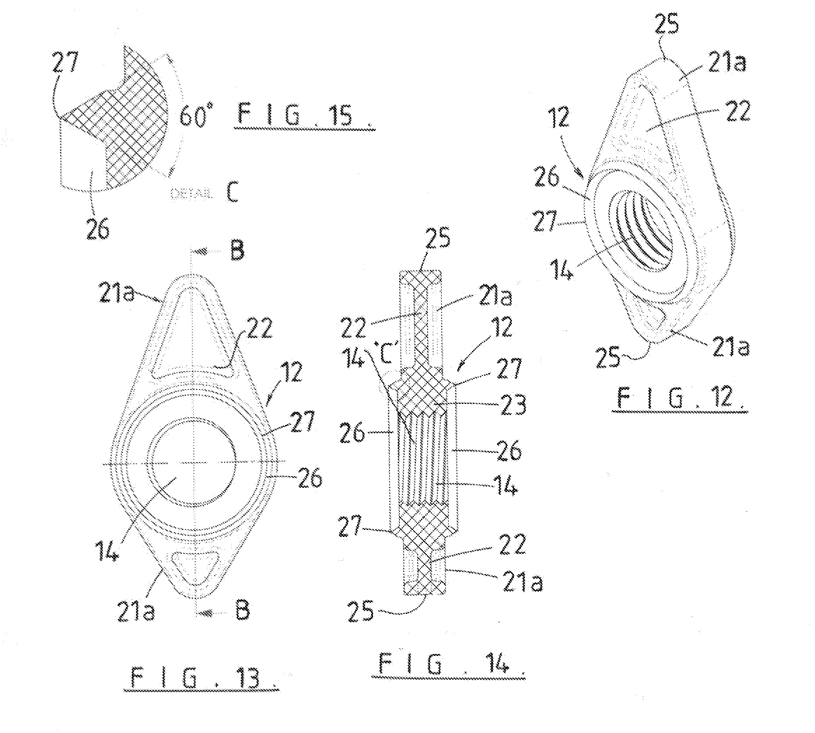

When the nut 12 is of the configuration shown in e.g. FIGS. 12 and 13 the longer of the wings 21a will come into contact with the floor L when the shorter of the wings 21a is too short to make contact with the floor L. This form of the nut 12 therefore is more versatile as it makes allowance for greater differences in distance of the opening O from the floor L.

Thus once a wing 21 (or one of wings 21a) has contacted the floor L the body 11 can be rotated until the land 20/surface 19 and edge 27 of wall 26 come into contact with the outer and inner wall surfaces respectively of the wall W of the feeder F. At this point a further slight rotation of the body 11 will cause the edge 27 of the wall 26 to bite into the inner surface of the wall W and ensure the land 20/surface 19 is against the outer surface of the wall W (with biting in of wall 31 if it is present). It will be appreciated from the drawings that wall 31 is preferably smaller and of less height than the primary sealing wall 26.

The biting of the edge 27 into the inner surface of the wall W will create a seal without the need for a sealing element such as an 0-ring or other form of annular seal. The seal created by leading edge 27 in the wall W will be sufficient to avoid leakage of feed in the feeder around the adaptor fitting 10. For this reason over tightening of the adaptor fitting should be avoided.

In a like manner the wall 33, if present, provides sealing at the outer surface of the feeder once again without the need for a sealing ring, gasket or the like.

In the preferred method of installation of the adaptor fitting 10 a teat is firstly screwed onto the body 1. This not only provides the user with a greater gripping area but also ensures that installation of the teat after the adaptor fitting has been fitted does not result in over tightening of the adaptor fitting. Thus the adaptor provides a means of correctly fitting a teat to a feeder.

The invention is open to modification as will be appreciated by the skilled person. For example, to prevent over tightening a further wall concentric to wall 26 could be provided. This wall can be slightly less in height compared with wall 26 and thus will come into contact with the inner surface of the wall W just after the edge 27 has sufficiently bit into the inner wall surface. This additional wall will be configured such that it does not bite into the inner wall surface.

A similar arrangement could be provided in conjunction with wall 33.

With multi-teat feeders it is sometimes the case that the user does not want all openings in the feeder to have a teat. The user can therefore simply put a threaded blanking plug in the adaptor fitting(s) 10 in place of the teat(s).

The present invention thus provides a simple yet very effective adaptor fitting that can be easily fitted into the opening in a wall of an animal feeder whereby a threaded animal-feeding teat can be mounted by the adaptor to the feeder. The adaptor fitting fits in a sealing manner without the need for a separate sealing element.

The adaptor fitting could be sold as an element of a kit of parts comprising the adaptor fitting and a teat of a type able to be fitted thereto. The kit could thus be used to convert a feeder to the teat type whereupon in the future the user would simply need to purchase teats alone when teat replacement becomes necessary.

The present invention has been described and illustrated by way of a specific embodiment. It is not the intention of the Applicant to restrict or in any way limit the scope of the invention to such an embodiment. Modifications and changes within the inventive concept will be apparent to the skilled person.

Therefore, the invention in its broader aspects is not limited to the specific details, representative means of manufacture and method, and illustrative examples shown and described in this specification. Accordingly departures may be made from such details without departing from the spirit or scope of the Applicant's general inventive concept.

1. An adaptor fitting which includes a first section adapted to receive a feeding teat, a second section engagable with the first section, the first and second sections adapted such that in use the first and second sections engage via an opening in the wall of a feeder such with the first and second sections respectively located at outer and inner sides of the feeder wall, the second section has a sealing part adapted such that, upon relative movement between the first and second sections, during fitment thereof to the feeder, the sealing part engages into the material from which the feeder wall is made to thereby create a seal around the opening in the feeder wall.

2. An adaptor fitting as claimed in claim 1 wherein the first and second sections have first and second engagement elements adapted to inter-engage via the opening in the feeder wall and cause the relative movement.

3. An adaptor fitting as claimed in claim 2 wherein the second section has a projecting portion adapted such that in use the projecting portion is engagable with an engagement surface of the feeder.

4. An adaptor fitting as claimed in claim 3 wherein the second section has a pair of opposed projecting portions of different length.

5. An adaptor fitting as claimed in claim 4 wherein the sealing part is an annular tapering wall.

6. An adaptor fitting as claimed in claim 5 wherein the annular tapering wall tapers toward a narrow edge.

7. An adaptor fitting as claimed in claim 6 wherein a further sealing part extends from the first section.

8. An adaptor fitting as claimed in claim 6 wherein the first engagement element is a threaded projection and the second engagement element is a threaded opening.

9. An adaptor fitting as claimed in claim 8 wherein a peripheral outer surface of the first section is provided with a gripping surface.

10. An adaptor fitting as claimed in claim 1 in combination with an animal feeder.

11. An animal feeder as claimed in claim 10 wherein the engagement surface is a floor of the feeder adjacent to the opening in the feeder wall.

12. A kit of parts comprising an adaptor fitting as claimed in claim 3 and an animal feeding teat able to be mounted to the adaptor fitting.

13. An adaptor fitting as claimed in claim 3 in combination with an animal feeder.
